(19) United States
(12) Patent Application Publication
(10) Pub. No.: US 2011/0131924 A1
(43) Pub. Date: Jun. 9, 2011

(54) Bottling Mechanism

(76) Inventor: Wendell Martin, Fort Smith, AR (US)

(21) Appl. No.: 12/959,972

(22) Filed: Dec. 3, 2010

Related U.S. Application Data
(60) Provisional application No. 61/266,157, filed on Dec. 3, 2009.

(51) Int. Cl. B67B 3/20

(52) U.S. Cl. 53/317

(57) ABSTRACT

A preferred embodiment includes an apparatus for distributing a horizontal force through angular communication with a neck ring of a bottle having at least one surface. One preferred embodiment includes a stationary member shaped to accommodate the bottle and securing mechanism extending from the stationary member ring having one or more projections and a member to convey a neck ring towards a bottle. A horizontal force transmits the bottle about the stationary member and upon contact with the one or more projections is distributed into vertical and horizontal components causing the one or more projections to penetrate the neck ring.

### CROSS REFERENCE TO RELATED APPLICATIONS

This application also claims Priority to: 1.) U.S. Provisional Application No. 61/266,157; filed 3 Dec. 2009, titled “Bottling Mechanism.”

### BACKGROUND OF THE INVENTION

1. Field of the Invention

The present invention relates to Bottling Technology. In particular, the present invention relates to Bottling Technology that may be implemented in Multiple Bottling Applications.

2. Description of Related Art

Presently bottling technology involves transitioning numerous bottles through a line of mechanical components, each of which performs a specific function. Bottles are first filled with a desired liquid and in time eventually the liquid is capped within the bottle. This is known as the capping phase. These steps often occur at a high frequency and involve the capping of tens if not hundreds of bottles per minute. The speed and accuracy at which bottle caps can be applied to a bottle neck is absolutely critical.

While fluid can be sealed within a bottle through numerous means which include enclosing the bottle via pressure fitting, using a type of threading mechanism, and numerous other applications, none is more desirable for an end user than a “capped” bottle.

Applying a threading mechanism about an open end of a bottle is one of the most effective and preferable methods. This is because, the amount of torque applied can be adjusted, controlled, and manipulated to meet the requirements for the necessary capping implementation. Using such a method is more desirable than pressure fitting a cap, both due to both property constraints and the ability to limit energy input. For example, it is not necessary to pressure fit a cap on a water bottle, because the escape of carbon from the bottle is not necessary. Similarly, less torque is necessary to seal a water bottle than that of a soda bottle. Supplying minimal amounts of torque in various applications is advantageous for numerous reasons including the exhaustion of less energy.

To that end, when torque is applied about a bottle, a natural tendency to spin occurs. To counteract the spin, bottles are often secured about the bottom via petal shaped plates. Additionally, small “knives” are located atop a portion of the caping mechanism, which physically “bite” into a portion of the bottle near its threads. Once the plates and “knives” have secured the bottle, torque is then applied about an opposing edge of the bottle, and in turn, the cap then seals the fluid within the bottom. Unfortunately, tendency to spin remains present which results in failures in the bottling process. These failures are believed to be in large part, a result of insufficiently securing a neck of a bottle, while simultaneous torsional loads are applied.

Although present systems represent great strides in the bottling technology, many shortcomings remain.

Thus there exists a need for an apparatus which secures the neck of a bottle.

### BRIEF DESCRIPTION OF THE DRAWINGS

The novel features believed to be characteristic of the invention are set forth in the appended claims. However, the invention itself, as well as a preferred mode of use and further objectives and advantages thereof, will best be understood by reference to the following detailed description when read in conjunction with the accompanying drawings, wherein:

FIG. 1 illustrates a perspective view of apparatus 10 and a bottle to be capped by apparatus 10.

FIG. 2 illustrates a side view of a bottle neck engaged by apparatus 10.

FIG. 3 illustrates a perspective view of an alternative embodiment of apparatus 10.

FIG. 4 illustrates a side view of apparatus 10.

FIG. 5 illustrates a forward view of apparatus 10.

### DETAILED DESCRIPTION OF THE PREFERRED EMBODIMENT

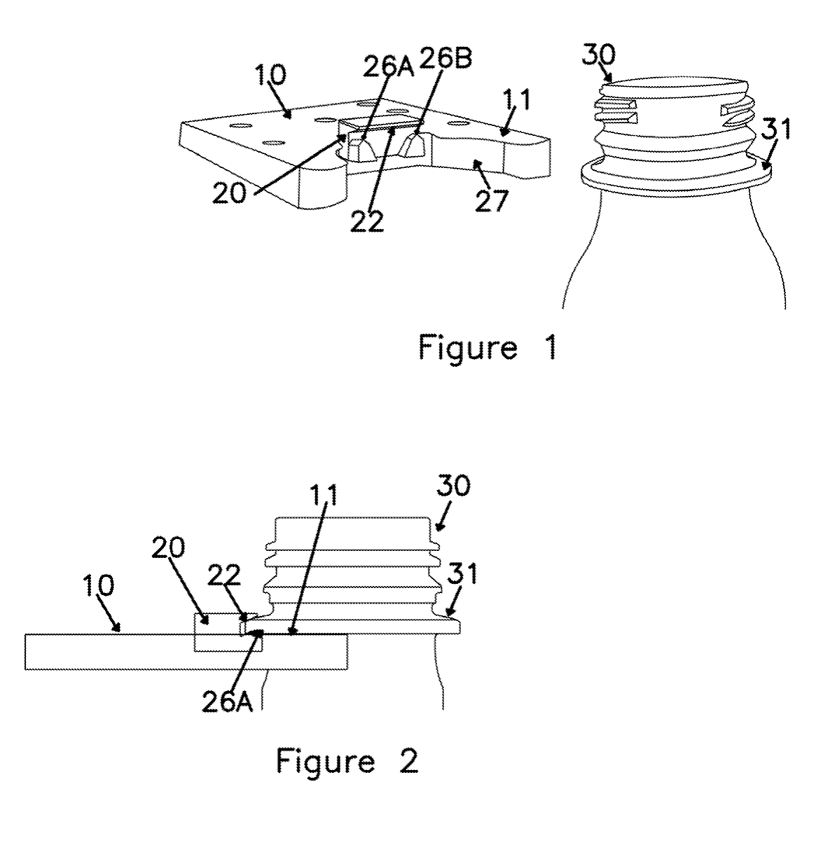

Referring now to the figures, FIG. 1 illustrates apparatus 10. Apparatus 10 is employed to distribute horizontal force through angular communication with a neck ring 31. Neck ring 31 and extends substantially perpendicular from a longitudinal orientation of a bottle. Apparatus 10 includes stationary member 11 which is fashioned according to the shape of a bottle. A securing mechanism 20 extends from stationary member 11. Projections 26A and 26B are formed from securing mechanism 20 and disposed opposite member 22. Member 22 slopes generally downward towards in order to guide neck ring 31 towards projections 26A and 26B.

Once a portion of neck ring 31 is transmitted towards securing mechanism 20, member 22 guides neck ring 31 towards projections 26A and 26B causing penetration of a lower surface of neck ring 21. As horizontal forces transmit bottle 30 towards securing mechanism 20 along radial length 27, and contact is made with neck ring 31, vertical and horizontal components are generated causing penetration of a lower surface of neck ring 21.

Once penetration has occurred, neck ring 31 becomes removably attached to apparatus 10 such that neck ring 31 rests just beyond an upper surface of stationary member 11. The body of bottle 30 remains engaged about stationary member 11 while neck member 31 remains confined within securing mechanism 20. At this point, bottle 30 is prevented from rotating and vertically shifting about the curvature of stationary mechanism 10. After bottle 30 becomes stabilized, a chucking mechanism installs a bottle cap about the top of bottle 30. Finally bottle cap 30 is released from securing mechanism 20 and conveyed beyond the radial length of stationary mechanism 20 as the curvature of securing mechanism 20 and stationary member 11 correspond.

Securing mechanism 20 includes several components which assist in the securitization of neck ring 31. Projections 26A and 26B are formed from securing mechanism 20 to establish points that remain sharp enough to pierce neck ring 31. An upper portion of securing mechanism 20 provides guidance such that a neck ring 31 can be transmitted towards projections 26A and 26B. Securing mechanism 20 is shaped according to the slope of an upper surface of neck ring 31 such that once a bottle is inserted into securing mechanism 20, the slope of the upper surface of neck ring 31 slides in accordance with the slope of upper portion of neck ring 31. As the slopes of each component meet along a horizontal path, neck ring 31 is transmitted horizontally and vertically such that a bottom portion of neck ring 31 is pierced by projections 26A and 26B. Projections 26A and 26B sufficiently pierce neck ring 31 such that neck ring 31 is prevented from rotating.

Referring now to FIG. 2, a side view of securing mechanism 20 of apparatus 10 is shown. FIG. 2 illustrates Neck ring 31 fully engaged by securing mechanism 20. Securing mechanism 20 is disposed within a channel of stationary member 11 such that projection 26A is disposed just above the top of stationary member 11. A gap between projection 26A and top portion of securing mechanism 20 extends according to the thickness of a neck ring to ensure that the neck ring fits snugly between projection 26A and lip portion 22. Securing mechanism 20 is shaped such that neck ring 31 prohibits portions of bottle 30 from striking another portion of securing mechanism 20. Neck ring 31 prevents damage to bottle 30 while providing securing point so that torsional forces may be properly applied to the threading of bottle 30 without damaging the chucking mechanism such that the bottle to remains fixed.

Edges of protruding members 26A and 26B are oriented substantially perpendicular to the longitudinal axis of stationary member 11. By orienting the edges perpendicular to the stationary member 11, a substantial penetration of neck ring 31 can be obtained. In certain embodiments, protruding members 26A and 26B extend substantially parallel to the orientation of the slope of the upper portion of member 22. In other embodiments, protruding members 26A and 26B extend substantially parallel to the orientation of stationary member 11.

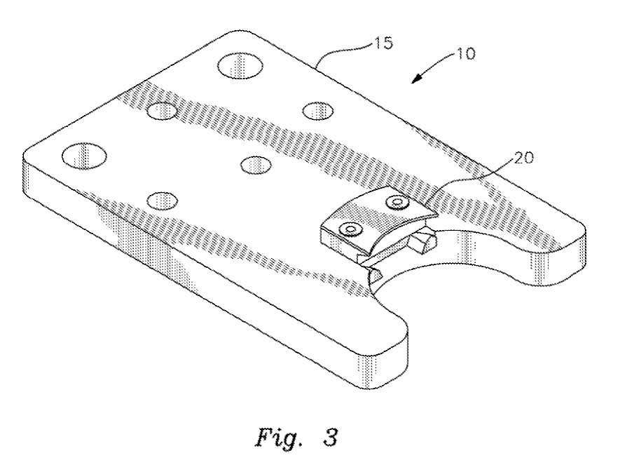

Referring now to FIG. 3, a perspective view of an alternative embodiment of apparatus 10 is illustrated where the shape of stationary member 11 is slightly different. As can be seen in FIG. 3, the curvature of securing mechanism 20 and stationary member 11 follow similar arcs. It is incumbent to note that in the present embodiment securing mechanism 20 attaches to stationary member 11 by being seated in a channel and coupled using two rivets.

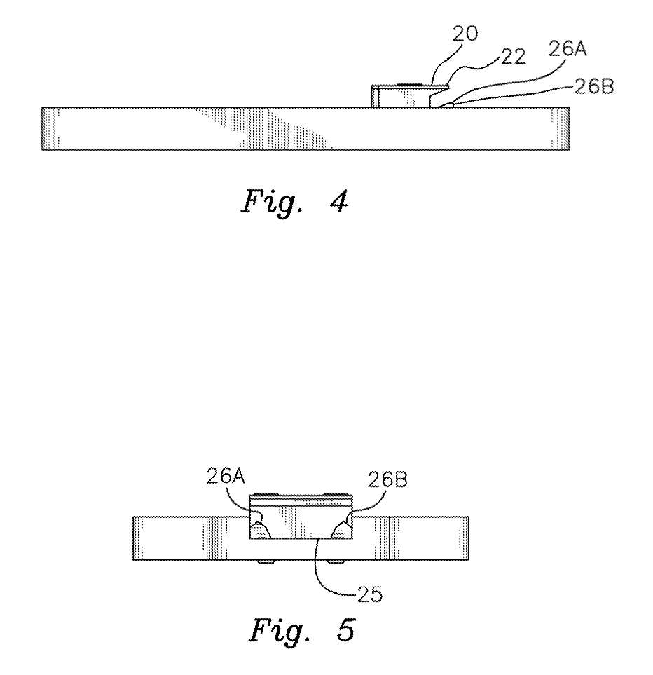

Referring now to FIG. 4, another side view of apparatus 10 as shown in FIG. 3 is illustrated. As is depicted in FIG. 4, securing mechanism 20 is seated within a channel such that protruding members 26A and 26B extend slightly above the surface of stationary member 11 and parallel to member 22. While it is preferable two protruding members 26A and 26B, in particular embodiments, various protruding members can be employed to extend at varying degrees of slope. For example, in certain embodiments member 22 may extend parallel to the surface of stationary member 11 and not parallel to protruding members 26A and 26B. In other embodiments, protruding members may extend at an angle less than or greater than they presently extend and may extend to a longer or shorter distance. Such embodiments would be preferable when neck rings of various sizes are required.

It should be noted that in a preferred embodiment bottle 30 preferably includes a neck ring with a generally flat lower portion and a curved upper portion. By using a bottle with a generally flat lower portion, protruding members 26A and 26B are more likely go get a better “bite” into a neck ring. However in alternative embodiments such as where a neck ring extended in a downward sloping manner protruding members 26A and 26B could be adjusted to “bite” into a neck ring at a particular angle. For example, if the lower surface of the neck ring were to extend downward, protruding members 26A and 26B could also extend generally downward, but be oriented such that the tips of the protruding members extend in a fashion substantially parallel to the slope of the lower portion of the neck ring.

In the event that a user desired to “bite” into a top portion of a neck ring, meaning that protruding members were oriented along the top portion of securing member 20, one could do so as long as a “bite” is achieved by running parallel to the slope of the portion of the neck ring into which it is biting.

Referring now to FIG. 5, a frontal view of apparatus 10 is illustrated. As is shown protruding members 26A and 26B extending from securing mechanism 20 which is disposed about channel 25. In this particular embodiment, protruding members 26A and 26B each include tip portions which are supported by more substantial bases. Protruding members 26A and 26B are generally disposed about the width of channel 25 in order to “bite” into the largest portion of a neck ring. Further channel 25 is disposed along the rear portion of stationary member 11 in order to ensure that the bottle neck is first properly seated before a proper bite can be achieved.

In certain embodiments, channel 25 and an accompanying securing mechanism 20 may extend to various lengths and include additional protruding members located at numerous locations. For example, in another embodiments channel 25 may extend to greater than or less than a quarter the radial length of stationary member 11. In such embodiments, additional protruding members may be employed. If, for example channel 25 were to extend to a quarter the radial length of the curvature of stationary member 11, three or four protruding members could be employed to further secure the mechanism. Similarly, if one desired to have protruding members “bite” into the top surface of a neck ring, protruding members could be disposed in a downward facing fashion and member 22 (shown in FIG. 4) could be oriented to slope upward. It should also be noted that in the present embodiment, securing mechanism 20 should be made of a different material than stationary member 11 and is preferably designed to be replaced after a certain number of capping iterations.

Various components of apparatus 10, including stationary member 11, and securing mechanism 20 may be made from a wide variety of materials. These materials may include metallic or non-metallic, magnetic or non-magnetic, elastomeric or non-elastomeric, malleable or non-malleable materials. Non-limiting examples of suitable materials include metals, plastics, polymers, wood, alloys, composites and the like. The metals may be selected from one or more metals, such as steel, stainless steel, aluminum, titanium, nickel, magnesium, or any other structural metal. Examples of plastics or polymers may include, but are not limited to, nylon, polyethylene (PE), polypropylene (PP), polyester (PE), polytetraflouroethylene (PTFE), acrylonitrile butadiene styrene (ABS), polyvinylchloride (PVC), or polycarbonate and combinations thereof, among other plastics. Apparatus 10 and its various components may be molded, sintered, machined and/or combinations thereof to form the required pieces for assembly. Furthermore each apparatus 10 and its various components may be manufactured using injection molding, sintering, die casting, or machining.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All of the compositions and/or methods disclosed and claimed herein can be made and executed without undue experimentation in light of the present disclosure. While the compositions and methods of this invention have been described in terms of various embodiments, it will be apparent to those of skill in the art that other variations can be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

1. An apparatus for distributing a horizontal force through angular communication with a neck ring of a bottle having at least one surface comprising:
A stationary member shaped to accommodate the bottle; and
A securing mechanism extending from the stationary member ring having one or more projections and a member to convey a neck ring towards a bottle;
Wherein a horizontal force transmits the bottle about the stationary member and upon contact with the one or more projections is distributed into vertical and horizontal components causing the one or more projections to penetrate the neck ring.

2. The apparatus of claim 1, wherein the stationary member and the securing mechanism are shaped in accordance with the curvature of the bottle and the neck ring.

3. The apparatus of claim 1, wherein the one or more projections are mounted about an interior portion of the stationary member.

4. The apparatus of claim 1, the securing mechanism extending according to the outermost radius of the neck ring.

5. The apparatus of claim 4, wherein the securing mechanism is disposed about the stationary member such that once the bottle is engaged, the horizontal force is distributed via the neck member.

6. The apparatus of claim 1, wherein the securing mechanism is formed from the stationary member.

7. An apparatus for distributing a horizontal force through angular communication with a neck ring of a bottle having at least one surface comprising:
A stationary member shaped to accommodate the bottle;
A securing mechanism extending from the stationary member ring having one or more projections;
A sloped member opposing the one or more projections, oriented according to the shape of the at least one surface of the neck ring;
wherein a horizontal force transmits the bottle about the stationary member and upon contact with the sloped component is transmitted towards the one or more projections via vertical and horizontal components causing the one or more projections to penetrate the neck ring.

8. The apparatus of claim 7, The apparatus of claim 1, wherein the stationary member and the securing mechanism are shaped in accordance with the curvature of the bottle and the neck ring.

9. The apparatus of claim 7, wherein the one or more projections are mounted about an interior portion of the stationary member.

10. The apparatus of claim 7, the securing mechanism extending according to the outermost radius of the neck ring.

11. The apparatus of claim 10, wherein the securing mechanism is disposed about the stationary member such that once the bottle is engaged, the horizontal force is distributed via the neck member.

12. The apparatus of claim 7, wherein the securing mechanism is formed from the stationary member.

13. The apparatus of claim 7, the securing member including an upper portion and a lower portion, the one or more projections extending from the lower portion and the sloped member extending from the upper portion.

14. The apparatus of claim 7, the securing member including an upper portion and a lower portion, the one or more projections extending from the upper portion and the sloped member extending from the lower portion.
